(19) United States
(12) Patent Application Publication
(10) Pub. No.: US 2022/0400380 A1
(43) Pub. Date: Dec. 15, 2022

(54) MAINTAINING CONTINUOUS WIRELESS SERVICE DURING POLICY ENFORCEMENT

(71) Applicant: AirEye Ltd., Hefer Valley (IL)

(72) Inventors: Roi Keren, Beit Halevi (IL); Ohad Plotnik, Savyon (IL); Amichai Shulman, Tel Aviv (IL); Shlomo Touboul, Kfar Chaim (IL)

(21) Appl. No.: 17/840,527

(22) Filed: Jun. 14, 2022

Related U.S. Application Data
(60) Provisional application No. 63/210,499, filed on Jun. 15, 2021.

(51) Int. Cl. H04W 12/12; H04L 9/40; H04W 12/73

(52) U.S. Cl. CPC H04W 12/12; H04L 63/20; H04W 12/73

(57) ABSTRACT

A wireless security method performed by a network monitoring system for a wireless station, the method maintaining continuous wireless service, the method including identifying a desired network, to which the wireless station is currently connected vis a legitimate access point, as having become an undesirable network, based on a network security policy, and based on network variables, activate the legitimate access point to create a desired network, comprising changing network variables of the undesired network, and maintaining the wireless station connection to the network, based on the security policy.

### PRIORITY REFERENCE TO PROVISIONAL APPLICATION

This application claims benefit of and hereby incorporates by reference U.S. Provisional Application No. 63/210,499, entitled MAINTAINING CONTINUOUS WIRELESS SERVICE DURING POLICY ENFROVEMENT, and filed on Jun. 15, 2021 by inventor Roi Keren.

### FIELD OF THE INVENTION

The present invention relates to wireless network connections.

### BACKGROUND OF THE INVENTION

Organization authority requires terminating a station's wireless network connection service from time to time. This may be done by the station requesting to terminate a session, or by the access point that provides wireless connectivity terminating the station's session. Session termination may be due to different reasons, such as inter alia unauthorized connection, bad reception, and security policy violation.

After session termination, the station loses its connectivity and is required to initiate a discovery of new access points and initiate connections to a new access point. It may well be that the station retries to connect to its previous undesired access point.

After session disconnection, station wireless service is terminated, and resumes only after finding a new allowed connection. Such new connection is initiated by the station. During this time, the station has lost connectivity and all sessions expire for an unknown time period.

Side effects may be inter alia loss of video session, conference, voice call, data exchange, and application authentication.

### SUMMARY

Embodiments of the present invention provide systems and methods for station connectivity termination while ensuring continuous wireless service via a desired network or access point. A station's undesired connection is terminated, while at the same time the access point or another wireless entity creates conditions for an immediate successful and desired connection.

Embodiments of the present invention do not allow the station to make a choice to reconnect to an undesired connection, and ensure that the connection is immediately established with a desired network/access point.

There is thus provided in accordance with an embodiment of the present invention a wireless security method performed by a network monitoring system for a wireless station, the method maintaining continuous wireless service, the method including identifying a network to which the wireless station is currently connected, as being an undesirable network based on a network security policy, disconnecting the wireless station from the undesirable network, creating an interim network, including copying an existing desired network in the vicinity of the wireless station, making the interim network favorable to the wireless station to connect, publishing the interim network, connecting the wireless station to the interim network; and stopping said publishing.

There is additionally provided in accordance with an embodiment of the present invention a wireless security method performed by a network monitoring system for a wireless station, the method maintaining continuous wireless service, the method including identifying a desired network, to which the wireless station is currently connected vis a legitimate access point, as having become an undesirable network, based on a network security policy, and based on network variables, activate the legitimate access point to create a desired network, including changing network variables of the undesired network, and maintaining the wireless station connected to the network, based on the security policy.

There is further provided in accordance with an embodiment of the present invention a wireless security method performed by a network monitoring system for a wireless station, the method maintaining continuous wireless service, the method including identifying a network to which the wireless station is currently connected, as being an undesirable network, based on a network security policy, disconnecting the wireless station from the undesirable network, strengthening announcement of an existing desired network in the vicinity of the wireless station, including echoing the announcement, making the echoed network favorable to the wireless station to connect, connecting the wireless station to the desired network, and stopping the echoing.

### BRIEF DESCRIPTION OF THE DRAWINGS

The present invention will be more fully understood and appreciated from the following detailed description, taken in conjunction with the drawings in which:

FIG. 1 is a simplified flowchart of a general workflow for maintaining continuous wireless service during policy enforcement, in accordance with an embodiment of the present invention;

FIG. 2 is simplified drawing of a first method for maintaining continuous wireless service during policy enforcement, by creating an interim existing desired network, in accordance with an embodiment of the present invention;

FIG. 3 is a simplified flowchart of a second method for maintaining continuous wireless service during policy enforcement, by echoing a desired network, in accordance with an embodiment of the present invention;

FIG. 4 is a simplified flowchart of a third method for maintaining continuous wireless service during policy enforcement, by creating alternative attractive desired networks, in accordance with an embodiment of the present invention; and

FIG. 5 is a simplified flowchart of a fourth method for maintaining continuous wireless service during policy enforcement, by creating a temporary safe network, in accordance with an embodiment of the present invention.

### DETAILED DESCRIPTION

“Undesired network variables” are configurable attributes of a wireless network that classify the network as an undesired network to the station's authority for security or performance reasons. For example, with 802.11 (Wi-Fi) the following attributes may be considered undesired variables:
Network service set identifier (SSID)
Access point basic service set identifier (BSSID)
Access point cipher suite, part of the recovery support network (RSN)
Authentication key management (AKM)

Undesired networks are classified by having undesired network variables or an undesired combination of network variables.

Embodiments of the present invention include four novel methods to establish an immediate station connection to a desired network/access point:
Method 1100: Create an interim existing desired network
Method 1200: Echo a desired network
Method 1300: Instant activation of an access point to create alternative attractive desired networks
Method 1400: Create a temporary safe network

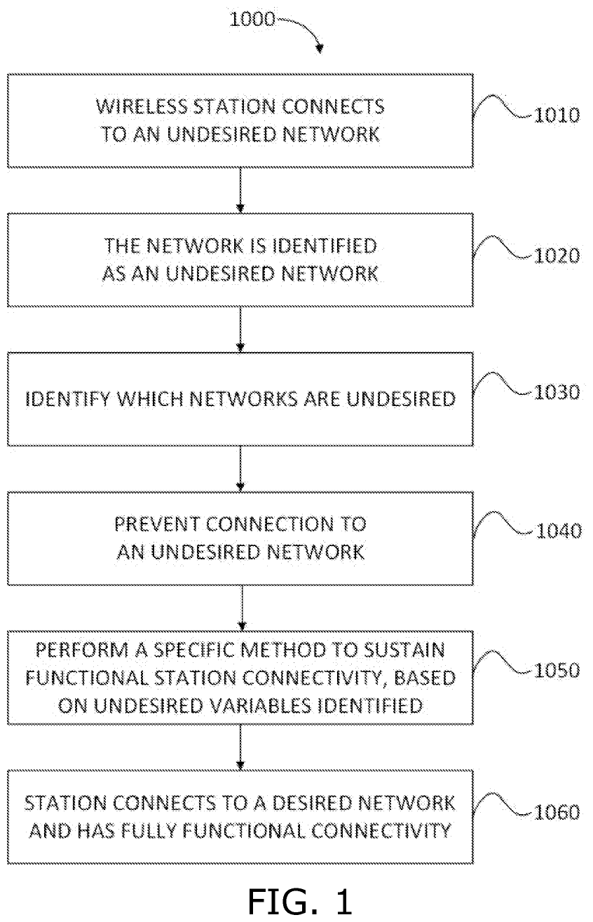

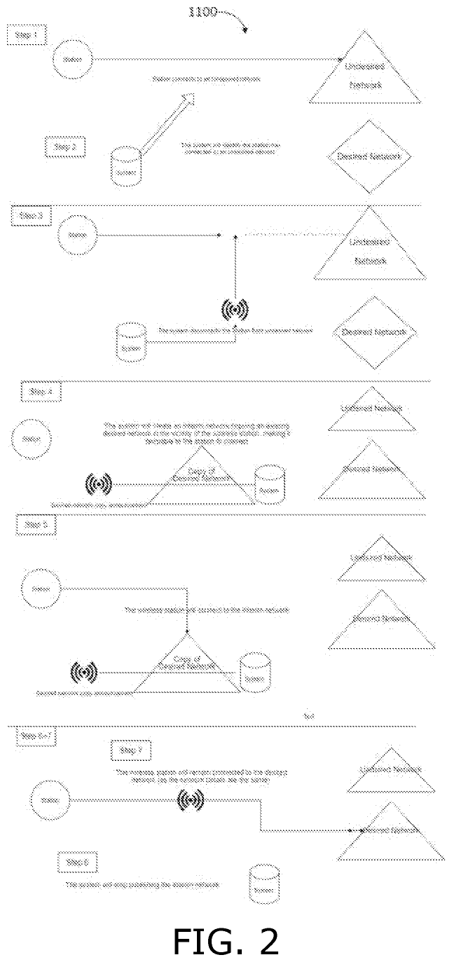

Reference is made to FIG. 1, which is a simplified flowchart of a general workflow 1000 for maintaining continuous wireless service during policy enforcement using any of methods 1100-1400 described hereinbelow, in accordance with an embodiment of the present invention. At operation 1010 a wireless station connects to an undesired network. At operation 1020 the network is identified as an undesired network. At operation 1030 other available networks which are undesired are detected. At operation 1040 connection to an undesired network is prevented. At operation 1050 functional station connectivity is sustained based on undesired variables identified, by using a method such as one of the methods illustrated in FIGS. 2-5. Finally, at operation 1060 the wireless station connects to a desired network and has fully functional connectivity.

Reference is made to FIG. 2, which is simplified drawing of a method 1100 for maintaining continuous wireless service during policy enforcement, by creating an interim existing desired network, in accordance with an embodiment of the present invention.

Method 1100 creates an interim existing desired network for continuous connectivity, and directs the station to a final desired network. As shown in FIG. 2, method 1100 performs the following operations.
A wireless station connects to an undesired network.
The network is identified an undesired network.
The wireless station is disconnected from the undesired network.
An interim network is created, copying an existing desired network in the vicinity of the wireless station, making it favorable to the station to connect, e.g., by a strong radio signal.
The wireless station connects to the interim network.
The interim network publishing is stopped.
The wireless station remains connected to the desired network, since the network details are the same, and communicates with the original desired network, thus maintaining productivity of connection on a desired network.

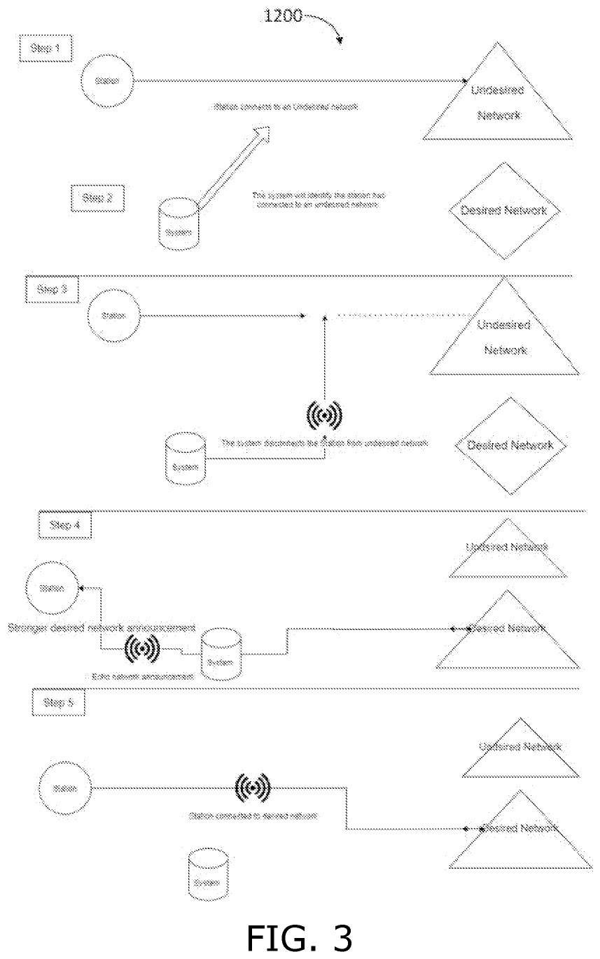

Reference is made to FIG. 3, which is a simplified flowchart of a method 1200 for maintaining continuous wireless service during policy enforcement, by echoing a desired network, in accordance with an embodiment of the present invention.

Method 1200 echoes announcement of a final desired network which may be located too far, i.e., low signal, to lure the station to connect to that desired network. As shown in FIG. 3, method 1200 performs the following operations.
A wireless station connects to an undesired network.
The network is identified as an undesired network.
The wireless station is disconnected from the undesired network.
An existing desired network in the vicinity of the wireless station is echoed, making it favorable to connect.
The wireless station connects to the echoed network.
The echoing procedure is stopped.
The wireless station remains connected to the desired network, thus maintaining productivity of connection on a desired network.

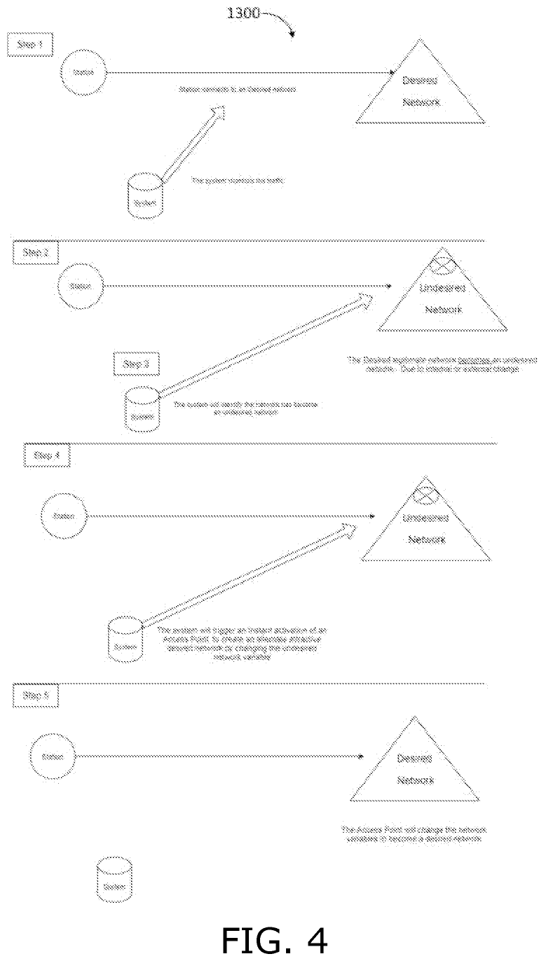

Reference is made to FIG. 4, which is a simplified flowchart of a method 1300 for maintaining continuous wireless service during policy enforcement, by creating alternative attractive desired networks, in accordance with an embodiment of the present invention. Method 1300 identifies that the network published from a legitimate access point has become an undesired network, and activates the legitimate access to execute changes to make the published network desired again. As shown in FIG. 4, method 1300 performs the following operations.
A wireless station connects to a desired legitimate network.
The desired legitimate network becomes an undesired network due to an internal change, e.g., management of the access point has changed an attribute of the network, or due to an external change, e.g. an external attack on the network.
The network is identified as having become an undesired network,
The legitimate access point is activated to change the undesired variable of the network.
The access point changes the network variables, and becomes a desired network.
The wireless station remains connected to a desired network, thus maintaining productivity of connection on the desired network.

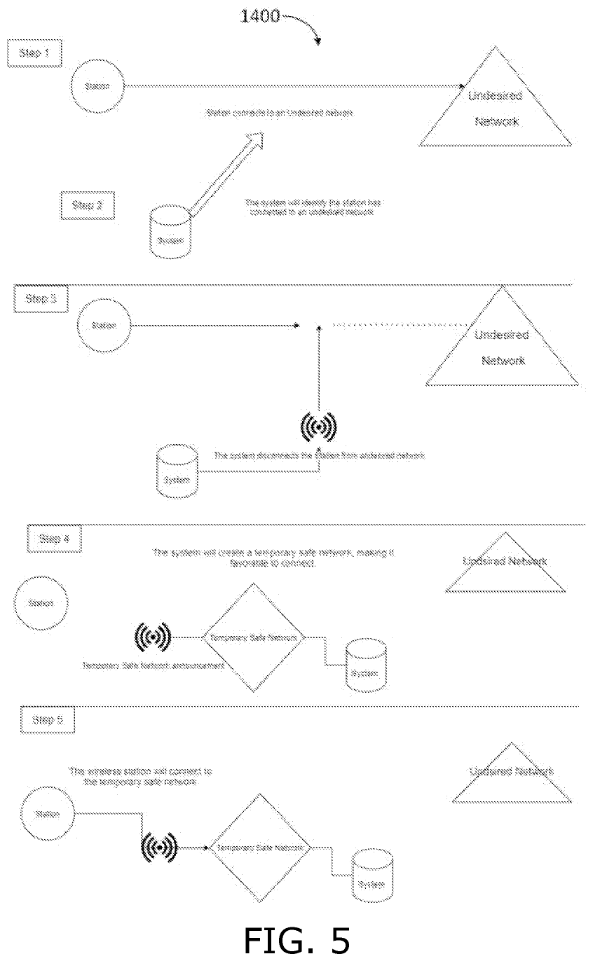

Reference is made to FIG. 5, which is a simplified flowchart of a method 1400 for maintaining continuous wireless service during policy enforcement, by creating a temporary safe network, in accordance with an embodiment of the present invention. Method 1400 connects a wireless terminal to a temporary safe network, preventing it from connecting to other undesired networks. As shown in FIG. 5, method 1400 performs the following operations.
A wireless station connects to an undesired network.
The network is identified as an undesired network.
The wireless station is disconnected from the undesired network.
A temporary safe network is created, making it favorable to connect.
The wireless station connects to the temporary safe network
The temporary safe network provides connectivity to the wireless station, thus maintaining productivity of connection on a desired network, or alternatively serves as a network to prevent the wireless station from connecting to undesired networks.

In the foregoing specification, the invention has been described with reference to specific exemplary embodiments thereof. It will, however, be evident that various modifications and changes may be made to the specific exemplary embodiments without departing from the broader spirit and scope of the invention. Accordingly, the specification is to be regarded in an illustrative rather than a restrictive sense.

What is claimed is:

1. A wireless security method performed by a network monitoring system for a wireless station, the method maintaining continuous wireless service, the method comprising:
identifying a network to which the wireless station is currently connected, as being an undesirable network based on a network security policy;
disconnecting the wireless station from the undesirable network;
creating an interim network, comprising copying an existing desired network in the vicinity of the wireless station;
making the interim network favorable to the wireless station to connect;
publishing the interim network;
connecting the wireless station to the interim network; and
stopping said publishing.

2. The method of claim 1 wherein said making the interim network favorable comprises use of a strong radio signal.

3. A wireless security method performed by a network monitoring system for a wireless station, the method maintaining continuous wireless service, the method comprising:
identifying a desired network, to which the wireless station is currently connected vis a legitimate access point, as having become an undesirable network, based on a network security policy, and based on network variables;
activate the legitimate access point to create a desired network, comprising changing network variables of the undesired network; and
maintaining the wireless station connected to the network, based on the security policy.

4. The method of claim 3 wherein the network variables used to determine that a network is undesirable include network service set identifier (SSID), access point basic service set identifier (BSSID), access point cipher suite, which is part of the recovery support network (RSN), and authentication key management (AKM).

5. The method of claim 3 wherein the desired network became an undesirable network due to an internal network change.

6. The method of claim 3 wherein the internal network change comprises management of the access point having changed one or more network attributes.

7. The method of claim 3 wherein the desired network became an undesirable network due to an external network change.

8. The method of claim 3 wherein the external network change comprises an external attack on the network.

9. A wireless security method performed by a network monitoring system for a wireless station, the method maintaining continuous wireless service, the method comprising:
identifying a network to which the wireless station is currently connected, as being an undesirable network, based on a network security policy;
disconnecting the wireless station from the undesirable network;
strengthening announcement of an existing desired network in the vicinity of the wireless station, comprising echoing the announcement;
making the echoed network favorable to the wireless station to connect;
connecting the wireless station to the desired network; and
stopping said echoing.
